(19) United States
(12) Patent Application Publication
(10) Pub. No.: US 2007/0082117 A1
(43) Pub. Date: Apr. 12, 2007

(54) Method for producing fish food, and fish food obtained using this method

(75) Inventor: Hubertus Adrianus Van Erp, Son (NL)

Correspondence Address: THE WEBB LAW FIRM, P.C., 700 KOPPERS BUILDING, 436 SEVENTH AVENUE, PITTSBURGH, PA, 15219, US

(73) Assignee: VAN GERVEN B.V., Son (NL)

(21) Appl. No.: 11/288,985

(22) Filed: Nov. 29, 2005

(30) Foreign Application Priority Data
Oct. 8, 2005 (NL) 1030144

(51) Int. Cl. A23K 1/00

(52) U.S. Cl. 426/635

(57) ABSTRACT

A method for producing fish food, which method comprises the following steps, to be performed in suitable sequence, of: providing porous dry grains with open structure, which grains comprise vegetable ingredients and/or animal ingredients; providing a mixture consisting of a mass of finely ground fresh or live fish food; impregnating the grains according to step (a) with the fish food according to step (b); preserving the thus obtained impregnated grains, for instance by freezing and keeping the grains frozen, freeze-drying the grains or air-drying the grains.

The invention relates to a method for producing fish food. It is known to manufacture extruded grains of dry food. Also known is ground fresh or live fish food, this latter being commercially available in, among other forms, compartmentalized packages which can be stored in a freezer.

It is an object of the invention to combine the advantages of the two stated types of fish food, which can improve the efficiency of feeding fish. Particularly the combination of fresh or live fish food with dry grains has the advantage that the fish are quickly enticed by the fresh or live fish food, which can be detected at a great distance by fish, wherein the cheaper ingredients of the dry grain are effectively also eaten during feeding.

The invention provides a method for producing fish food, which method comprises the following steps, to be performed in suitable sequence, of:

(a) providing porous dry grains with open structure, which grains comprise vegetable ingredients and/or animal ingredients;

(b) providing a mixture consisting of a mass of finely ground fresh or live fish food;

(c) impregnating the grains according to step (a) with the fish food according to step. (b);

(d) preserving the thus obtained impregnated grains.

Preserving can take place in different ways. The method can for instance comprise step (e) of performing step (d) by freezing and keeping the grains frozen, for instance up to a temperature of less than −15° C.

It can also comprise step (f) of performing step (d) by freeze-drying the grains. It can further comprise step (g) of performing step (d) by air-drying the grains.

The method is preferably embodied such that the ingredients for the vegetable grains according to step (a) are chosen from the group to which belong: vegetables, grains, flour, seeds, grasses, herbs, vegetable oil, and/or the ingredients for the animal grains are chosen from the group to which belong fish meal and fish oil.

According to another aspect, the invention has the special feature that the fresh or live fish food is chosen from the group to which belong: red mosquito larvae, white mosquito larvae, black mosquito larvae, cyclops, daphnia, bosmides, red plankton, micro-plankton, artemia, mysis, krill pacifica, krill superba, green fodder, mussel meat, roe, cockle meat, beef heart, spleen, shrimp meat, shrimp paste, gammarus, tubifex, crab eggs and squid.

It is of great importance that the impregnation treatment takes place effectively such that an intimate mixing of the fresh or live fish food and the dry grains takes place. For this purpose the method preferably comprises step (h) of performing step (c) by
(h.1) mixing the mass according to step (b) with the dry grains according to step (a) such that at least a part of this mass becomes attached to the surface of the grains through adhesion and there penetrates superficially through capillary action;
(h.2) placing the mixture obtained in (h.1) into an airtight closable chamber;
(h.3) reducing the air pressure in the chamber substantially, for instance to 0.3 bar;
(h.4) restoring the atmospheric air pressure in the chamber, whereby the mass adhered to the grains penetrates deeply into the pores of the grains and the grains thus become impregnated therewith; and
(h.5) removing the thus impregnated grains from the chamber.

Of further importance can be a method comprising step (i) of manufacturing the dry grains according to step (a) by
(i.1) extruding a pasty basic mass consisting of the ingredients chosen therefor, while supplying air;
(i.2) forming the extrudate into grains; and
(i.3) drying the grains according to step (i.2) or drying the extrudate prior to performing step (i.2).

To make the extrusion operation as effective as possible and provide the option of also feeding the fish food according to the invention to small and even very small fish, the method can comprise step (j) of performing step (b) such that the fish food is finely ground in advance to a particle size of a maximum of 30 μm, preferably a maximum of 10 μm.

A favourable mixing ratio here is generally found to be that the ratio of the mass of the dry grains and the fresh or live fish food lies substantially in the range of (60±15)%:(40±15)%.

In order to enable marketing of the fish food obtained with any of the above specified methods, use is preferably made of step (k) of portioning and packaging the produced fish food in suitable manner.

Finally, the invention relates to fish food obtained by applying a method of the above specified type. This fish food comprises porous grains with an open structure, which grains are impregnated with fresh or live fish food and preserved.

1-12. (canceled)

13. A method for producing fish food, comprising:
providing porous dry grains with an open structure, the porous dry grains comprising vegetable ingredients, animal ingredients, or any combination thereof;
providing a mass of finely ground fresh or live fish food;
impregnating the porous dry grain with the mass thereby yielding impregnated grains; and
preserving the impregnated grains.

14. The method as claimed in claim 13, wherein preserving the impregnated grains comprises freezing and keeping the impregnated grains frozen at a temperature of less than about −15° C.

15. The method as claimed in claim 13, wherein preserving the impregnated grains comprises freeze-drying the impregnated grains.

16. The method as claimed in claim 13, wherein preserving the impregnated grains comprises air-drying the impregnated grains.

17. The method as claimed in claim 13, wherein ingredients for the porous dry grains comprise vegetables, grains, flour, seeds, grasses, herbs, vegetable oil, fish meal, fish oil, or any combination thereof.

18. The method as claimed in claim 13, wherein the fresh or live fish food comprises red mosquito larvae, white mosquito larvae, black mosquito larvae, cyclops, daphnia, bosmides, red plankton, micro-plankton, artemia, mysis, krill pacifica, krill superba, green fodder, mussel meat, roe, cockle meat, beef heart, spleen, shrimp meat, shrimp paste, gammarus, tubifex, crab eggs, squid, or any combination thereof.

19. The method as claimed in claim 13, wherein impregnating the porous dry grains with the mass thereby yielding impregnated grains comprises:
mixing the mass with the porous dry grains, allowing at least a part of the mass to become attached to a surface of the porous dry grains through adhesion and penetrates the surface superficially through capillary action, thereby producing a mixture;
placing the mixture into an airtight closable chamber;
reducing an air pressure in the chamber to about 0.3 bar;
restoring an atmospheric air pressure in the chamber, whereby the mass adhered to the porous dry grains penetrates deeply into pores of the porous dry grains and the porous dry grains are thus impregnated therewith producing impregnated grains; and
removing the impregnated grains from the chamber.

20. The method as claimed in claim 13, further comprising: manufacturing the porous dry grains by
extruding a pasty basic mass while supplying air to form an extrudate;
forming the extrudate into grains; and
drying the grains.

21. The method as claimed in claim 13, wherein providing a mass of finely ground fresh or live fish food comprises finely grinding the fresh or live fish food in advance to a particle size of at most 30 μm.

22. The method as claimed in claim 13, wherein a ratio of a mass of the porous dry grains and the fresh or live fish food is substantially in a range of (60±15)%:(40±15)%.

23. The method as claimed in claim 13, further comprising:
portioning and packaging the preserved, impregnated grains.

24. Fish food obtained by applying the method of claim 13, the fish food comprising porous grains with an open structure, wherein the porous grains are impregnated with fresh or live fish food and preserved.

25. The method as claimed in claim 21, wherein the particle size is at most 10 μm.

26. The method as claimed in claim 20, wherein ingredients for the pasty basic mass comprises vegetables, grains, flour, seeds, grasses, herbs, vegetable oil, fish meal, fish oil, or any combination thereof.

27. The method as claimed in claim 13, further comprising:
manufacturing the porous dry grains by:
extruding a pasty basic mass while supplying air to form an extrudate;
drying the extrudate; and
forming the extrudate into grains.
